(19) United States
(12) Patent Application Publication
(10) Pub. No.: US 2026/0249690 A1
(43) Pub. Date: Aug. 27, 2026

(54) DISPLAY CONTROL DEVICE AND DISPLAY CONTROL METHOD

(71) Applicant: Nissan Motor Co., Ltd., Kanagawa (JP)

(72) Inventor: Ryuji Kurosaki, Kanagawa (JP)

(73) Assignee: Nissan Motor Co., Ltd., Kanagawa (JP)

(21) Appl. No.: 18/860,861

(22) PCT Filed: Mar. 8, 2023
(86) PCT No.: PCT/JP2023/008780

§ 371 Date: Oct. 28, 2024

(30) Foreign Application Priority Data
May 12, 2022 (JP) 2022-078800

(51) Int. Cl. B60K 35/28; B60K 35/10; B60K 35/22; B60K 35/81

(52) U.S. Cl. CPC B60K 35/28; B60K 35/10; B60K 35/22; B60K 35/81; B60K 2360/1446; B60K 2360/162; B60K 2360/167; B60K 2360/175

(57) ABSTRACT

A display control device includes a switch which is operated in a preparatory operation and outputs an operating command to an operation target device in response to a confirmatory operation after the preparatory operation; and a controller for controlling a display device and an autonomous driving. The controller obtains vehicle state information indicating at least one of a current state of a vehicle and a state of a surrounding environment of the vehicle. The controller specifies, on a basis of the vehicle state information, a detail of control of the vehicle the operation target device and deactivation of the autonomous driving when the switch is operated in the preparatory operation, the control being to be executed in response to the operating command. The controller causes the display device to display the detail of the control before the confirmatory operation, the display device to display the deactivation of the autonomous driving.

### TECHNICAL FIELD

The present invention relates to a display control device and a display control method.

The present application claims priority based on Japanese Patent Application No. 2022-078800 filed on May 12, 2022, and for designated countries where incorporation by reference to literature is permitted, the contents described in the above-described application are incorporated herein by reference and made a part of the description herein.

### BACKGROUND ART

There has been known an information display device for a vehicle that facilitates grasping a state of an operation (e.g., Patent Document 1). In an information display device for a vehicle according to Patent Document 1, operating switches for controlling operation target devices installed in the vehicle, such as an air conditioner, are disposed on a steering wheel. On a windshield WS of the vehicle, switch images corresponding to the operating switches are displayed in a pattern reflective of a layout of the operating switches on the steering wheel. In addition, a touch sensor is built in each of the operating switches. When a user touches the touch sensor, a corresponding switch image is highlighted. When one of the operating switches is operated, an operating signal is transmitted to a corresponding device, and the device performs an action corresponding to the operating signal and responds to the operating signal with a state of the action, and an action response image that represents the state of the action is displayed on the windshield WS.

### PRIOR ART DOCUMENT

### Patent Document

Patent Document 1: JP 2007-106353 A

### SUMMARY OF INVENTION

### Problems to Be Solved by Invention

However, the information display device for a vehicle only displays the switch images reflective of the layout of the operating switches on the windshield, and there is such a problem that an occupant can recognize details of control of the vehicle to be executed in response to an operation of an operating switch only after the occupant performs a confirmatory operation to confirm an operating command to control the vehicle.

An object of the present invention is to provide a display control device and a display control method that enable an occupant to recognize details of control of a vehicle to be executed in response to an operation of a switch before a confirmatory operation of the switch.

### Means for Solving Problems

The present invention solves the problem by obtaining vehicle state information and, when a switch is operated in a preparatory operation, specifying, on a basis of the vehicle state information, details of control of a vehicle to be executed in response to an operating command from the switch and causing, before a confirmatory operation of the switch, a display device to display the details of the control of the vehicle.

### Effects of Invention

According to the present invention, it is possible for an occupant to recognize details of control of a vehicle to be executed in response to an operation of a switch before the confirmatory operation of the switch.

### BRIEF DESCRIPTION OF DRAWINGS

FIG. 1 is a block diagram of a vehicle that includes a display control device according to the present embodiment.

FIG. 2A is a conceptual diagram illustrating a situation of an interior of the vehicle seen by a driver facing forward in the vehicle.

FIG. 2B is a conceptual diagram illustrating a situation of the interior of the vehicle seen by the driver facing forward in the vehicle.

FIG. 2C is a conceptual diagram illustrating a situation of the interior of the vehicle seen by the driver facing forward in the vehicle.

FIG. 3A is a conceptual diagram illustrating a situation of the interior of the vehicle seen by the driver facing forward in the vehicle.

FIG. 3B is a conceptual diagram illustrating a situation of the interior of the vehicle seen by the driver facing forward in the vehicle.

FIG. 3C is a conceptual diagram illustrating a situation of the interior of the vehicle seen by the driver facing forward in the vehicle.

FIG. 4 is a flowchart illustrating a process flow of display control by a controller.

### MODE(S) FOR CARRYING OUT THE INVENTION

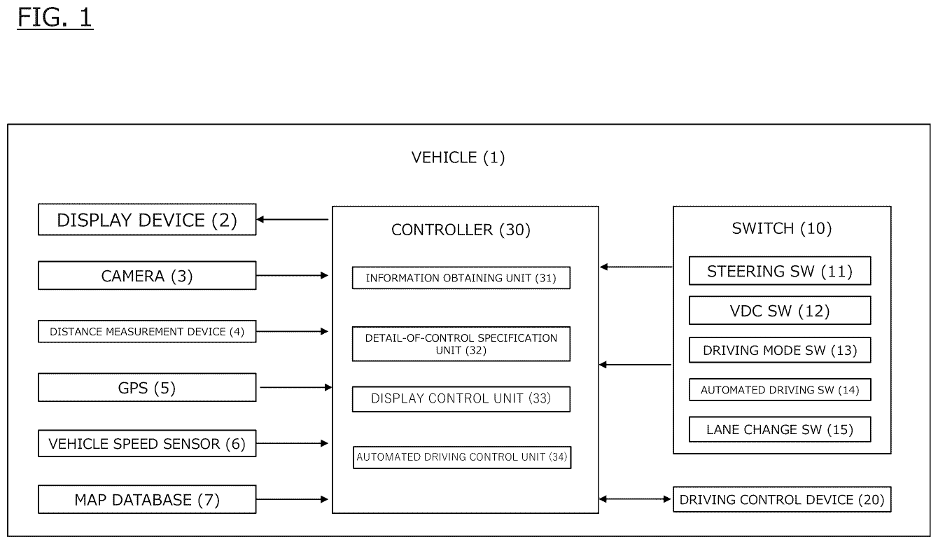

An embodiment of a display control device according to the present invention will be described with reference to the drawings. FIG. 1 is a block diagram illustrating an example of a configuration of a vehicle that includes a display control device according to the present embodiment. As illustrated in FIG. 1, a vehicle 1 includes a display device 2, a camera 3, a distance measurement device 4, a GPS 5, a vehicle speed sensor 6, a map database 7, a switch 10, a driving control device 20, and a controller 30. The display control device according to the present embodiment is a device including the controller 30. The display control device receives an operating command from the switch 10, which supports at least a two-step operation. A first-step operation causes the display control device to display details of control to be executed in response to the operating command from the switch 10, on the display device 2. A second-step operation of the switch 10 causes the display control device to execute a control process on onboard equipment according to the details of the control based on the operating command. That is, the display control device displays, on the display device 2, the details of the control to be executed in response to the operating command before a second-step switch operation is performed in order to confirm the operating command for controlling the vehicle. An occupant of the vehicle 1 can recognize, on the display device 2, the details of the control of the vehicle to be executed in response to the second-step switch operation before performing the second-step switch operation. Thus, the occupant can operate the switch 10 with security.

The display device 2 is a display for displaying details of control of the vehicle 1 to be executed in response to an operating command from the switch 10. The display device 2 includes at least one of, for example, a head-up display, a display installed in a dashboard, and a display included in a navigation system. The head-up display is a display device that displays an image on a glass or a projection plate positioned at a front part of the vehicle.

The display device 2 displays details of control of the vehicle 1 in a form of a message image with a character string or a pictorial image such as an icon. The display device 2 generates an image to be displayed on a basis of a control command transmitted from the controller 30 and displays the image on a screen.

The camera 3 is a camera for capturing images of a surrounding environment of the vehicle 1. The camera 3 is installed in the vehicle 1 and includes a front camera, a rear camera, and/or side cameras of the vehicle 1. The images captured by the camera 3 include vehicle state information indicating a state of the surrounding environment of the vehicle 1 and are used in autonomous driving control of the vehicle 1.

The distance measurement device 4 is a sensor for detecting the surrounding environment of the own vehicle. The distance measurement device 4 is installed in the vehicle 1 and includes a front radar detecting an obstacle forward of the own vehicle, a rear radar detecting an obstacle rearward of the own vehicle, and/or side radars detecting obstacles present on right and left sides of the own vehicle. Detection data from the distance measurement device 4 includes vehicle state information indicating a state of the surrounding environment of the vehicle 1 and is used in the autonomous driving control of the vehicle 1.

The GPS (the navigation system) 5 is a system that includes a GPS receiver (GPS) receiving signals from satellites and measures a current position of the vehicle 1. The vehicle speed sensor 6 detects a vehicle speed of the vehicle 1 as a current state of the vehicle (a traveling state). Although the vehicle speed sensor 6 is illustrated in FIG. 1 as an example of a sensor that detects the current state of the vehicle, the sensor that detects the current state of the vehicle may be of another type such as an acceleration sensor or a torque sensor.

The map database 7 stores three-dimensional high-definition map information that includes positional information on various facilities or specific points. The three dimensional high-definition map information is three-dimensional map information based on road shapes detected by means of a vehicle for obtaining data when the vehicle travels on actual roads. The three-dimensional high-definition map information is map information that includes map information associated with detailed, high-definition positional information on curved roads and their sizes (e.g., their curvatures or curvature radii), locations where roads merge, locations where a road diverges, tollgates, locations where the number of lanes reduces, and the like as three-dimensional information. Note that the high-definition map does not cover all roads, and the map database 7 stores a standard-definition map (SD map) so as to cover information on roads and the like that are not covered by the high-definition map (HD map).

The switch (SW) 10 is a switch for operating operation target devices. The switch 10 is a switch that supports a multi-step operation. The switch 10 has a function that enables an operation to be performed in at least two steps. In a two-step operation of the switch 10, a first operation corresponds to a preparatory operation, and a second operation corresponds to a confirmatory operation. When an occupant operates the switch 10 in the preparatory operation, the switch 10 outputs a preparatory command indicating the preparatory operation to the controller 30, and when the occupant operates the switch 10 in the confirmatory operation, the switch 10 outputs an operating command indicating the confirmatory operation (an operation confirmatory command) to the controller 30. The switch 10 has such an operating mechanism that makes an operating method for the preparatory operation and an operating method for the confirmatory operation different from each other. The switch 10 is a switch including an electrostatic or pressure-sensitive touch sensor (an electrostatic switch, a pressure-sensitive switch), a two-step switch that enables a half press and a full press (a mechanical switch), or the like.

For example, in a case where the switch 10 is a switch including a touch sensor, the switch 10 detects an input operation in a form of a touch operation as the preparatory operation and outputs the preparatory command to the controller 30. The switch 10 detects a touch operation as the confirmatory operation when the touch operation takes a longer contact time than that of the touch operation for the preparatory operation, and the switch 10 outputs the confirmatory command to the controller 30. The touch operation for the preparatory operation is, for example, a tap operation that takes a shorter contact time, and the touch operation for the confirmatory operation is, for example, a touch operation that takes a longer contact time. Note that the touch operation for the preparatory operation and the touch operation for the confirmatory operation are preferably operating methods different from each other. For example, the preparatory operation may be a tap operation, and the confirmatory operation may be a double tap operation.

For example, in a case where the switch 10 is a two-step switch, the switch 10 detects an input operation in a form of a touch operation (a half press) as the preparatory operation and outputs the preparatory command to the controller 30. The switch 10 detects an operation of pushing in a part touched in the preparatory operation (a full press) as the confirmatory operation and outputs the operating command to the controller 30.

The switch 10 includes various switches provided in the vehicle 1 that include a steering switch (steering SW) 11, a VDC switch (VDC SW) 12, a traveling mode switch (traveling mode SW) 13, an autonomous driving switch (autonomous driving SW) 14, and a lane change switch (lane change SW) 15. The steering SW 11 is a switch provided on a steering wheel. The steering SW 11 includes, for example, a touch sensor installed in a rim, mechanical switches installed on spoke parts, and the like. The touch sensor in the rim detects that a driver (occupant) touches the steering wheel. The switches in the spoke parts include a switch for operating the navigation system, a video/audio system, and the like, a switch for switching a traveling mode in the autonomous driving control from one to another, a switch for adjusting a set vehicle speed in the autonomous driving control, a switch for adjusting a distance from a preceding vehicle in the autonomous driving control, and the like.

The VDC SW 12 is a switch that switches on and off of a system for preventing a skid of the vehicle 1 (a vehicle dynamics control system: VDC system). The traveling mode SW 13 is a switch that switches, for example, on and off of a traveling mode such as a snow mode or a sport mode. The autonomous driving switch 14 is a switch for switching on and off of autonomous driving. The lane change switch 15 is a switch for switching on and off of a lane change assistance function during the autonomous driving. Note that all of the switches included in the switch 10, such as the steering switch 11, need not be switches that support the multi-step operation.

The driving control device 20 controls traveling of the own vehicle. For example, in a case where the own vehicle performs cruise traveling at a set speed by means of an automatic speed control function, the driving control device 20 controls an action of a driving mechanism and actions of brakes to accelerate, decelerate, and maintain a traveling speed so that the own vehicle travels at the set speed. In a case where the own vehicle travels following a preceding vehicle by means of the automatic speed control function, the driving control device 20 also controls the actions of the driving mechanism and the brakes. In a case of an internal combustion engine vehicle, the control of the action of the driving mechanism includes an action of an internal combustion engine, and in a case of electric vehicles, the control includes an action of a drive motor. In addition, in a case of a hybrid vehicle, the control includes a torque split between an internal combustion engine and a drive motor.

In addition to the control of the actions of the driving mechanism and the brakes, the driving control device 20 controls an action of a steering actuator by means of an automatic steering control function, thus executing steering control of the own vehicle. For example, in a case where the driving control device 20 executes lane keeping control by means of the automatic steering control function, the driving control device 20 detects lane markings of the own vehicle's lane on which the own vehicle travels, and the driving control device 20 controls a traveling position of the own vehicle in a width direction of the own vehicle in such a manner that the own vehicle travels keeping itself in a predetermined position in the own vehicle's lane. In a case where the driving control device 20 executes the lane change assistance function, a passing assistance function, or a route traveling assistance function by means of the automatic steering control function, the driving control device 20 controls the traveling position of the own vehicle in the width direction in such a manner that the own vehicle makes a lane change. In a case where the driving control device 20 executes a right-left-turn assistance function by means of the automatic steering control function, the driving control device 20 performs traveling control of right or left turn at an intersection or the like. The driving control device 20 can also execute the autonomous driving in a hands-on mode or a hands-off mode. The hands-on mode refers to a mode in which the automatic steering control does not work unless a driver holds the steering wheel, and the hands-off mode refers to a mode in which the automatic steering control works even when a driver's hands are off the steering wheel. The driving control device 20 controls traveling of the own vehicle in response to a control command from the controller 30. Note that another known method can be used as a method for the traveling control by the driving control device 20.

The controller 30 has a function of obtaining the vehicle state information, a function of specifying details of control of the vehicle, a function of controlling the display device 2, a function of controlling the autonomous driving, and the like. The controller 30 includes a processor that executes a display control method according to the present embodiment. The controller 30 includes, as functional blocks, at least an information obtaining unit 31, a detail-of-control specification unit 32, a display control unit 33, and an autonomous driving control unit 34. The functional blocks execute their respective functions through cooperation of software and hardware (the processor). Note that the functional blocks included in the controller 30 need not necessarily be divided into as with the functional blocks illustrated in FIG. 1, and the number of the functional blocks is not limited, either. To cause the functional blocks to function, the controller 30 includes a CPU, a ROM, a RAM, and the like.

The information obtaining unit 31 obtains the vehicle state information from the camera 3 and the like. The vehicle state information indicates at least one of the current state of the vehicle 1 and the state of the surrounding environment of the vehicle 1 and corresponds to images captured by the camera 3, detection values from the distance measurement device 4, a vehicle position measured by the GPS 5, and a vehicle speed detected by the vehicle speed sensor 6. The vehicle state information also includes information about the autonomous driving controlled by the driving control device 20. The current state of the vehicle 1 is a state of the vehicle 1 traveling or stopping or being parked and is represented in a form of, for example, the current position of the vehicle 1, the vehicle speed of the vehicle 1, or an acceleration of the vehicle 1. The information obtaining unit 31 obtains the current position of the vehicle from the GPS 5 and the vehicle speed from the vehicle speed sensor 6. The state of the surrounding environment of the vehicle 1 is represented in a form of the images captured by the camera 3 or the detection values from the distance measurement device 4.

When the switch 10 is operated in the preparatory operation, the detail-of-control specification unit 32 specifies details of control of the vehicle 1 to be executed in response to the operating command from the switch 10, on a basis of the vehicle state information. When an occupant operates the switch 10 in the preparatory operation, the detail-of-control specification unit 32 receives the preparatory command from the switch 10. Since the switch 10 is a switch supporting the multi-step operation, the detail-of-control specification unit 32 receiving the preparatory command can specify a possibility that the switch 10 will be operated in the confirmatory operation after the preparatory command. For example, in a case where a preparatory operation of the steering switch 11 is performed, the detail-of-control specification unit 32 can specify that a confirmatory operation of the steering switch 11 will be performed after the preparatory operation of the steering switch 11.

On a basis of the preparatory command from the switch 10, the detail-of-control specification unit 32 specifies the details of control of the vehicle 1 to be executed in response to the operating command from the switch 10. Before receiving the operating command from the switch 10, the detail-of-control specification unit 32 specifies the detail of the control of the vehicle 1. The details of the control of the vehicle 1 include at least details of control of an operation target device of the switch 10. In a case where control of an onboard device other than the operation target device is to be subjected to the operating command, the details of the control of the vehicle 1 also include details of control of the onboard device to be subjected to the operating command. This will be described with an example.

A condition that the VDC SW 12 is on is assumed as an example of a condition for maintaining the autonomous driving. While the vehicle 1 is traveling in the autonomous driving, a driver performs a preparatory operation of the VDC SW 12 to switch the VDC SW 12 from on to off. When receiving a preparatory command from the VDC SW 12, the detail-of-control specification unit 32 obtains the vehicle state information at a time of the preparatory operation from the information obtaining unit 31. In the autonomous driving, the vehicle state information includes information indicating that the autonomous driving is being executed. From the preparatory operation of the VDC SW 12, the detail-of-control specification unit 32 specifies that the VDC system, which is a control target of the VDC SW 12, is to be switched from on to off. Switching the VDC system from on to off is details of control specified by the detail-of-control specification unit 32.

In addition, from the preparatory operation of the VDC SW 12, the detail-of-control specification unit 32 specifies that switching the VDC system from on to off is to deactivate the autonomous driving. That is, the driving control device 20 corresponds to the onboard device other than the operation target device that is to be subjected to an operating command from the VDC SW 12. The deactivation of the autonomous driving is the details of the control specified by the detail-of-control specification unit 32. This enables the detail-of-control specification unit 32 to specify, before a confirmatory operation of the VDC SW 12, the details of the control of the operation target device (the VDC system) to be executed in response to the operating command from the VDC SW 12. In addition, the detail-of-control specification unit 32 can specify, before the confirmatory operation of the VDC SW 12, details of control of a device (the driving control device 20), out of onboard devices other than the operation target device (the VDC system), to be executed in response to the operating command from the VDC SW 12.

Before the confirmatory operation of the switch 10, the display control unit 33 causes the display device 2 to display the details of the control specified by the detail-of-control specification unit 32. When a driver performs the preparatory operation of the switch 10, the display control unit 33 causes the display device 2 to display the details of the control of the vehicle 1 so that the driver can recognize the details of the control. As in the example mentioned above, it is assumed that the driver performs the preparatory operation of the VDC SW 12 to switch the VDC SW 12 from on to off while the vehicle 1 is traveling in the autonomous driving. The detail-of-control specification unit 32 specifies “switching the VDC system from on to off” and “deactivation of the autonomous driving” as the details of the control of the vehicle 1. The display control unit 33 then causes the display device 2 to display an image indicating that the VDC system is to be switched from on to off, and that the autonomous driving is to be deactivated. Specifically, the display control unit 33 displays message images such as those showing “The VDC system will be switched from on to off” and “The autonomous driving will be deactivated.” Since the details of the control are displayed before the confirmatory operation of the switch 10, a driver recognizes that the confirmatory operation of the switch 10 is to cause the deactivation of the autonomous driving in addition to switching the VDC system from on to off. This enables the driver to grasp a state of the vehicle brought about by the confirmatory operation before performing the confirmatory operation of the switch 10 pertaining to controlling the vehicle, and thus the driver can operate the switch 10 with security.

The autonomous driving control unit 34 controls the driving control device 20 under the operating command from the switch 10. For example, in a case where a confirmatory operation for switching the lane change switch 15 from on to off is performed in the autonomous driving, the autonomous driving control unit 34 transmits a control command to execute the lane change assistance function to the driving control device 20. In a case where the autonomous driving is deactivated in response to the operating command from the switch 10, the autonomous driving control unit 34 transmits a control command to deactivate the autonomous driving to the driving control device 20. For example, as in the example mentioned above, a driver performs the preparatory operation of the VDC SW 12 to switch the VDC SW 12 from on to off while the vehicle 1 is traveling in the autonomous driving, and the display control unit 33 then causes the display device 2 to display an image indicating that the VDC system is to be switched from on to off, and that the autonomous driving is to be deactivated. When the driver thereafter performs the confirmatory operation of the VDC SW 12, the autonomous driving control unit 34 transmits a control command to switch the VDC system from on to off to the VDC system and transmits the control command to deactivate the autonomous driving to the driving control device 20.

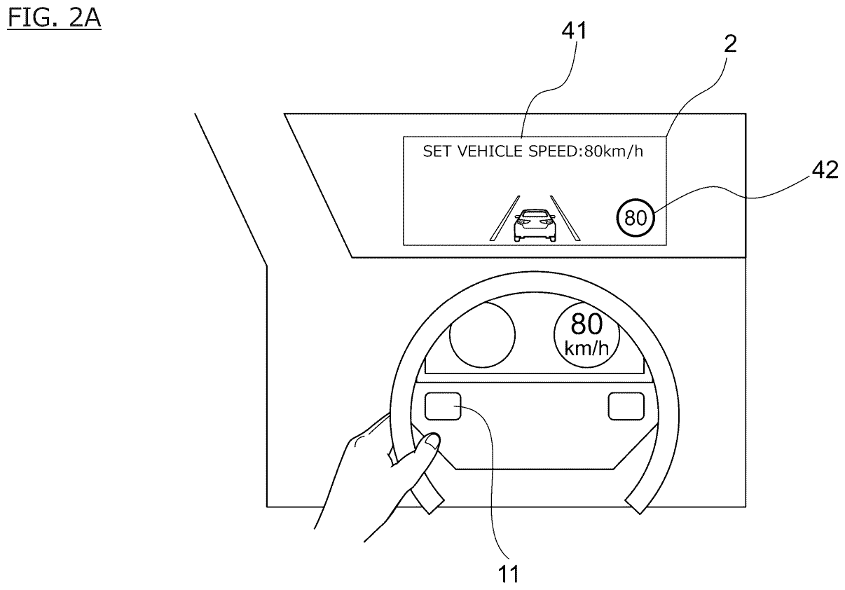

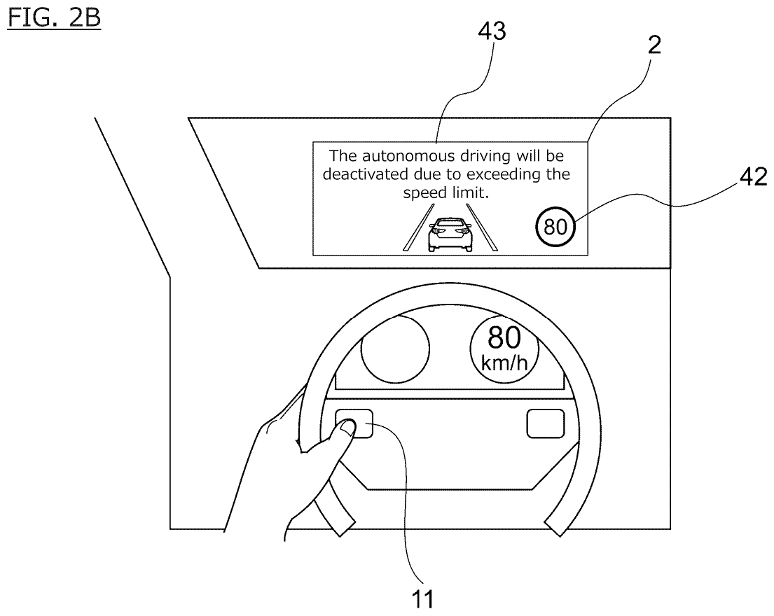

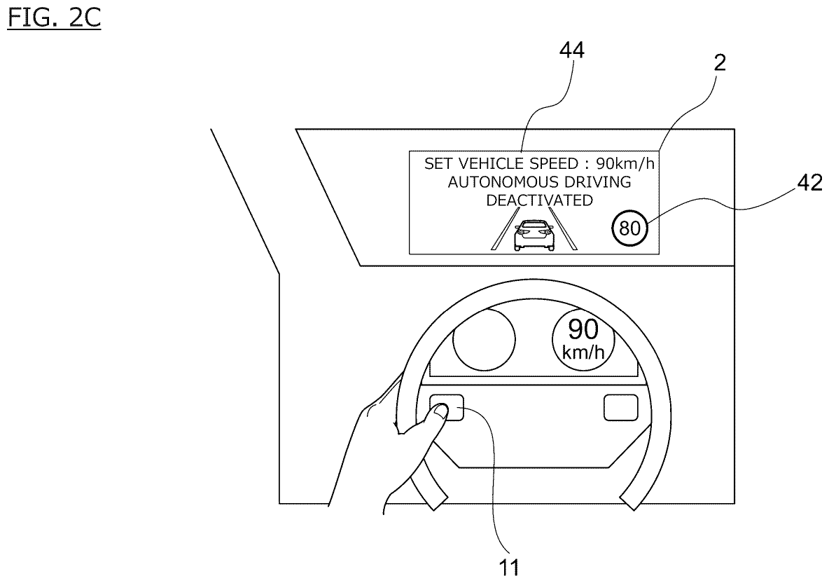

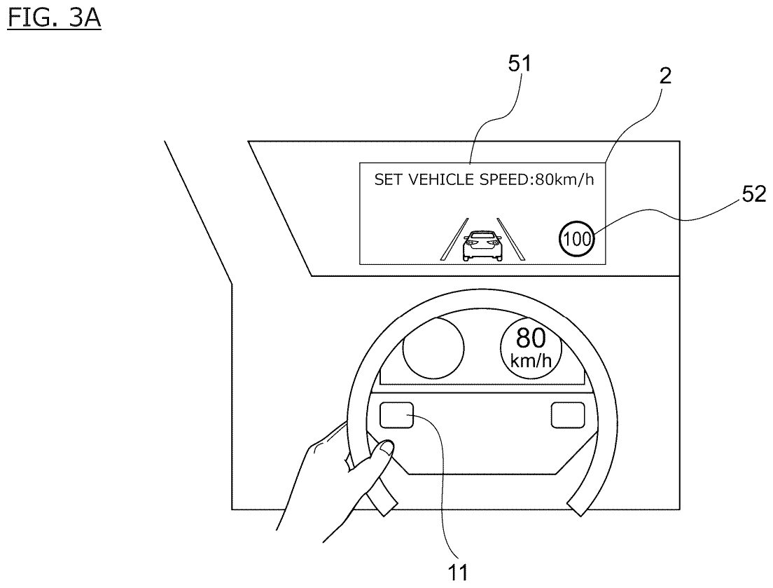

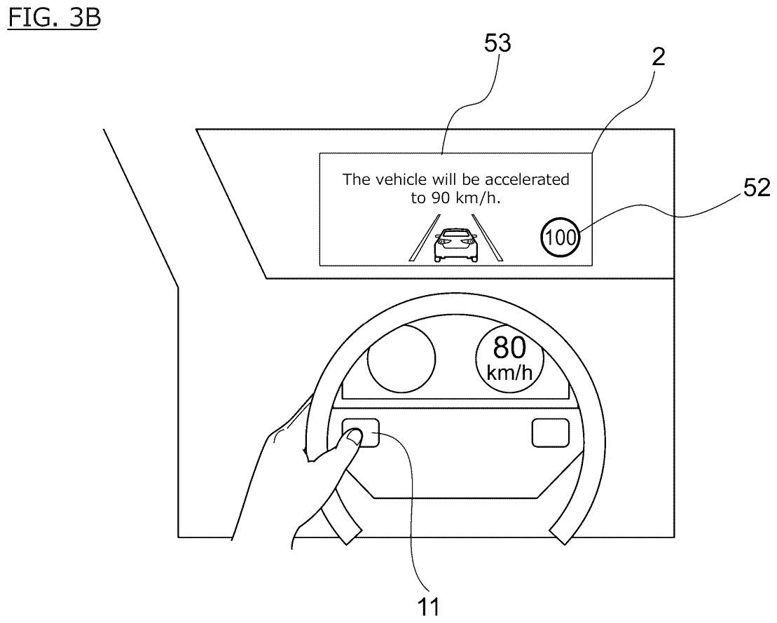

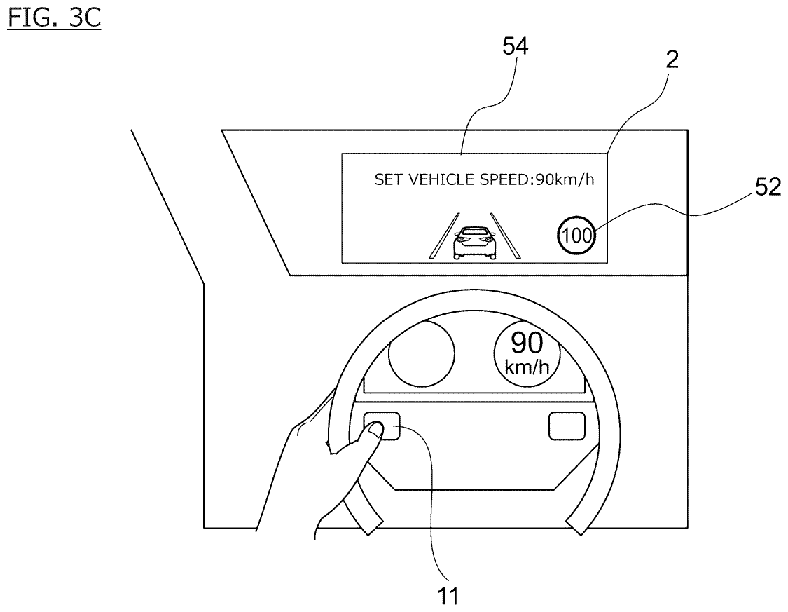

With reference to FIG. 2A to FIG. 2C and FIG. 3A to FIG. 3C, specific examples of control processes by the controller 30 and a display screen of the display device 2 will be described. FIG. 2A to FIG. 2C and FIG. 3A to FIG. 3C are conceptual diagrams each illustrating a situation of a vehicle interior seen by a driver facing forward. FIG. 2A to FIG. 2C and FIG. 3A to FIG. 3C are diagrams each describing transitions of the display screen that is switched in response to operations of the switch 10. In the specific examples described below, the display device 2 is assumed to be the head-up display. The steering SW 11 is a switch for raising the set speed in the autonomous driving. Performing a confirmatory operation of the steering SW 11 once raises the set speed by 10 km/h.

In the example in FIG. 2A, the set speed in the autonomous driving is set to 80 km/h, and a current vehicle speed of the vehicle 1 is 80 km/h. Note that a speed limit is 80 km/h. While the vehicle is traveling, the information obtaining unit 31 obtains the vehicle state information from the GPS 5, the vehicle speed sensor 6, the map database 7, and the driving control device 20. The vehicle state information includes, as information indicating the current state of the vehicle, the current position and the current vehicle speed of the vehicle, and the autonomous driving being executed, and the vehicle state information includes the map information as information indicating the state of the surrounding environment of the vehicle 1. Note that the information indicating the current state of the vehicle 1 may include, for example, a current steering angle, and the information indicating the surrounding environment of the vehicle 1 may include images captured by the camera 3.

The detail-of-control specification unit 32 specifies a current set speed and a legal speed limit from the vehicle state information. As illustrated in FIG. 2A, the display control unit 33 displays a message image 41 of the current set speed (80 km/h) and an icon image 42 indicating the speed limit (80 km/h) on the display device 2 as images indicating details of current control of the vehicle 1.

When the driver touches the steering SW 11, the steering SW 11 detects a preparatory operation and outputs a preparatory command to the controller 30. The detail-of-control specification unit 32 specifies how performing the confirmatory operation of the steering SW 11 changes the details of the control of the vehicle 1 from the vehicle state information at a time when the preparatory command is received. In the example in FIG. 2A, when the driver performs the confirmatory operation of the steering SW 11, the autonomous driving is deactivated because the set vehicle speed becomes 90 km/h to be higher than the speed limit (80 km/h). The detail-of-control specification unit 32 specifies that the confirmatory operation of the steering SW 11 is to cause the set speed to become higher than the legal speed limit and cause the deactivation of the autonomous driving, as the details of the control of the vehicle to be executed in response to an operating command from the steering SW 11. As illustrated in FIG. 2B, the display control unit 33 displays, as an image indicating the details of the control to be executed in response to the operating command from the steering SW 11, a message image 43 “The autonomous driving will be deactivated due to exceeding the speed limit” on the display device 2 in addition to the icon image 42.

When the driver pushes in the steering SW 11, the steering SW 11 detects a confirmatory operation and outputs an operating command to the controller 30. On a basis of the operating command from the steering SW 11, the driving control device 20 changes the set speed from 80 km/h to 90 km/h and deactivates the autonomous driving. The information obtaining unit 31 obtains the vehicle state information from the driving control device 20. The vehicle state information includes the set speed having been changed from 80 km/h to 90 km/h and the autonomous driving having been deactivated. The detail-of-control specification unit 32 specifies the current set speed, the legal speed limit, and the autonomous driving having been deactivated, from the vehicle state information. As illustrated in FIG. 2C, the display control unit 33 causes the display device 2 to display a message image 44 of the current set speed (90 km/h) and the deactivation of the autonomous driving and display the icon image 42, as images indicating the details of the current control of the vehicle 1.

When the driver releases the driver's fingers from the steering SW 11 in the state where touching the steering SW 11 by the driver causes the display device 2 to display the image illustrated in FIG. 2B, the display control unit 33 turns the display screen of the display device 2 back to the state in FIG. 2A.

Next, with reference to FIG. 3A to FIG. 3C, the specific examples of control processes by the controller 30 and the display screen of the display device 2 will be described. The specific examples in FIG. 3A to FIG. 3C differ from the specific examples described above with reference to FIG. 2A to FIG. 2C in that the speed limit is 100 km/h and are the same in the rest of the state of the vehicle. The following description will be given differences from the specific examples in FIG. 2A to FIG. 2C.

As illustrated in FIG. 3A, the display control unit 33 displays a message image 51 of the current set speed (80 km/h) and an icon image 52 indicating the speed limit (100 km/h) on the display device 2 as images indicating the details of the current control of the vehicle 1. When a driver touches the steering SW 11, and the controller 30 receives a preparatory command from the steering SW 11, the detail-of-control specification unit 32 specifies how performing the confirmatory operation of the steering SW 11 changes the details of the control of the vehicle 1, from the vehicle state information at a time when the preparatory command is received. In the example in FIG. 3A, when the driver performs the confirmatory operation of the steering SW 11, the autonomous driving is maintained because the set vehicle speed becomes 90 km/h and the changed set vehicle speed (90 km/h) is lower than the speed limit (100 km/h). The detail-of-control specification unit 32 specifies that the confirmatory operation of the steering SW 11 is to maintain a state where the set speed is lower than the legal speed limit, as the details of the control of the vehicle to be executed in response to the operating command from the steering SW 11. As illustrated in FIG. 3B, the display control unit 33 causes the display device 2 to display, as an image indicating the details of the control to be executed in response to the operating command from the steering SW 11, a message image 53 “The vehicle will be accelerated to 90 km/h,” in addition to the icon image 52. The message image 53 enables the driver to grasp what state of the vehicle is to result from performing the confirmatory operation of the steering SW 11.

When the driver pushes in the steering SW 11, the driving control device 20 changes the set speed from 80 km/h to 90 km/h and maintains the autonomous driving on a basis of the operating command from the steering SW 11. The detail-of-control specification unit 32 specifies the current set speed, the legal speed limit, and the autonomous driving being executed, from the vehicle state information. As illustrated in FIG. 3C, the display control unit 33 causes the display device 2 to display a message image 54 of the current set speed (90 km/h) and the icon image 52, as images indicating the details of the current control of the vehicle 1.

Specific examples of switches of the switch 10 other than the steering SW 11 will be described. For example, the driving control device 20 measures a distance from a preceding vehicle and controls actions of an accelerator/brakes and the action of the steering actuator by means of the automatic speed control function and the automatic steering control function in such a manner as to travel at the vehicle speed up to the set speed while keeping the distance from the preceding vehicle in accordance with the vehicle speed. A condition that the traveling mode is a normal mode is assumed as an example of a condition for maintaining such autonomous driving. While the vehicle 1 is traveling in the autonomous driving, a driver performs a preparatory operation of the traveling mode switch 13 to switch the traveling mode switch 13 from the normal mode to the snow mode. The information obtaining unit 31 obtains the vehicle state information at a time when a preparatory command is received from the traveling mode switch 13. The vehicle state information includes information indicating that the autonomous driving is being executed. On a basis of the vehicle state information, the detail-of-control specification unit 32 specifies that switching from the normal mode to the snow mode is to deactivate the autonomous driving. That is, the detail-of-control specification unit 32 specifies “switching the traveling mode from the normal mode to the snow mode” and “deactivation of the autonomous driving” as the details of the control of the vehicle 1. The display control unit 33 then causes the display device 2 to display an image indicating that the traveling mode is to be switched from the normal mode to the snow mode, and that the autonomous driving is to be deactivated.

A specific example of the autonomous driving switch 14 will be described. For example, a condition that a lane can be detected from images captured by the camera 3 and a condition that the position of the vehicle 1 can be measured by the GPS 5 are assumed as conditions for executing the autonomous driving by means of the automatic steering control function. While the vehicle 1 is traveling in normal driving rather than the autonomous driving, a driver performs a preparatory operation of the autonomous driving switch 14 to switch from the normal driving to the autonomous driving. It is assumed at this time that the surrounding environment is in such a state that bad weather disables detection of a lane from images captured by the camera 3 (a lane detection disabled state). The information obtaining unit 31 obtains the vehicle state information at a time when a preparatory command is received from the autonomous driving switch 14. The vehicle state information includes images captured by the camera 3. The autonomous driving control unit 34 specifies the lane detection disabled state from the images captured by the camera 3 and determines that the execution of the autonomous driving is disabled. The detail-of-control specification unit 32 specifies that “the execution of the autonomous driving is disabled” as the details of the control of the vehicle 1. The display control unit 33 then causes the display device 2 to display an image indicating that the autonomous driving cannot be executed.

In a case where the GPS 5 cannot measure the position of the vehicle 1, the information obtaining unit 31 obtains information indicating that the position cannot be measured from the GPS 5 as the vehicle state information. The autonomous driving control unit 34 specifies a position measurement disabled state from a result of the measurement by the GPS 5 and determines that the execution of the autonomous driving is disabled. The detail-of-control specification unit 32 specifies that “the execution of the autonomous driving is disabled” as the details of the control of the vehicle 1. The display control unit 33 then causes the display device 2 to display an image indicating that the autonomous driving cannot be executed.

As another example, the autonomous driving cannot be executed also in a case where the sensors such as the distance measurement device 4 and the vehicle speed sensor 6 do not work normally. The information obtaining unit 31 obtains a result of detection by the sensors from the distance measurement device 4, the vehicle speed sensor 6, and the like as the vehicle state information at a time when the preparatory command is received from the autonomous driving switch 14. The result of the detection by the sensors indicates a detection error. The autonomous driving control unit 34 specifies the detection error of the sensors and determines that the execution of the autonomous driving is disabled. The detail-of-control specification unit 32 specifies that “the execution of the autonomous driving is disabled” as the details of the control of the vehicle 1. The display control unit 33 then causes the display device 2 to display an image indicating that the autonomous driving cannot be executed.

As another example, the hands-off mode cannot be maintained in a case where the current position of the vehicle 1 is not covered by the high-definition map. At a time when the preparatory command is received from the autonomous driving switch 14, the information obtaining unit 31 obtains the current position of the vehicle 1 from the GPS 5 and obtains the map information from the map database 7, as the vehicle state information. The autonomous driving control unit 34 determines whether the current position of the vehicle is covered by the high-definition map, and when the current position is not covered by the high-definition map, the autonomous driving control unit 34 determines that the autonomous driving in the hands-off mode is disabled. From a result of the determination by the autonomous driving control unit 34, the detail-of-control specification unit 32 specifies that “the execution of the autonomous driving in the hands-off mode is disabled” as the details of the control of the vehicle 1. The display control unit 33 then causes the display device 2 to display an image indicating that the autonomous driving in the hands-off mode cannot be executed.

As another example, the autonomous driving by the lane change assistance function cannot be executed in a case where another vehicle approaches the vehicle 1. During the autonomous driving, the information obtaining unit 31 obtains images captured by the camera 3 and/or a result of detection by the distance measurement device 4 as the vehicle state information at a time when a preparatory command is received from the lane change switch 15. From the images captured by the camera 3 and/or the result of detection by the distance measurement device 4, the autonomous driving control unit 34 determines whether another vehicle approaches a periphery of the vehicle 1, and when the other vehicle approaches the periphery of the vehicle 1, the autonomous driving control unit 34 determines that the lane change by the autonomous driving is disabled. From a result of the determination by the autonomous driving control unit 34, the detail-of-control specification unit 32 specifies that “the lane change by the autonomous driving is disabled” as the details of the control of the vehicle 1. The display control unit 33 then causes the display device 2 to display an image indicating that lane change control by the autonomous driving cannot be executed.

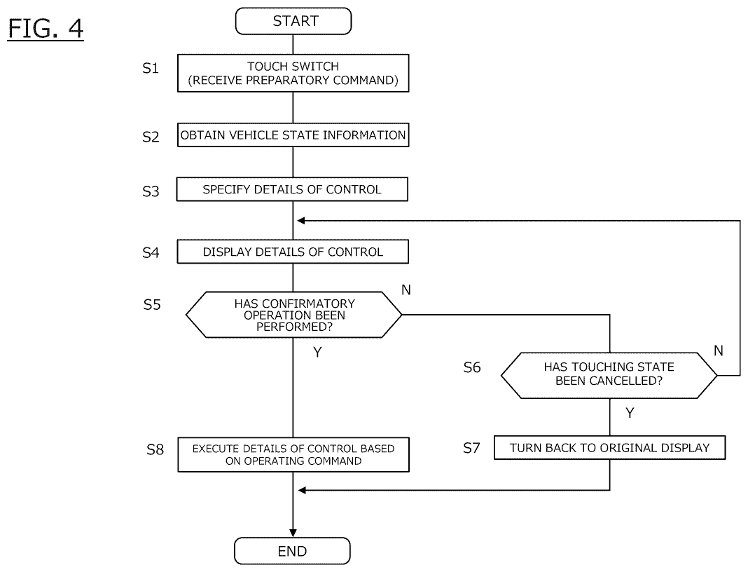

Next, with reference to FIG. 4, the display control method executed by the controller 30 will be described. FIG. 4 is a flowchart illustrating a flow of the control process by the controller 30.

In step S1, when a driver touches the switch 10 to operate the switch 10 in the preparatory operation, the controller 30 receives the preparatory command from the switch 10. In step S2, the information obtaining unit 31 of the controller 30 obtains the vehicle state information at a time when the preparatory command is received. In step S3, on a basis of the vehicle state information, the detail-of-control specification unit 32 of the controller 30 specifies the details of the control of the vehicle 1 to be executed in response to the operating command from the switch 10.

In step S4, the display control unit 33 of the controller 30 displays, on the display device 2, the details of the control specified by the detail-of-control specification unit 33. In step S5, the controller 30 determines whether the operating command from the switch 10 has been received to determine whether the confirmatory operation of the switch 10 has been performed. When determining that the confirmatory operation of the switch 10 has not been performed, the controller 30 determines in step S6 whether the state of touching the switch 10 (a touching state) has been canceled. For example, in a case where the controller 30 does not receive the operating command within a predetermined time period from a time at which the controller 30 receives the preparatory command from the switch 10, the controller 30 determines that the touch state has been canceled. In a case where the touching state has not been canceled, the controller 30 executes the control process of step S4. In a case where the touching state has been canceled, the display control unit 33 of the controller 30 turns in step S7 the display screen displayed in the control process of step S3 back to an original display screen. The controller 30 then finishes the control flow.

When it is determined in the determination process of step S5 that the confirmatory operation of the switch 10 has been performed, the autonomous driving control unit 34 of the controller 30 executes, in step S8, details of control based on the operating command from the switch 10. The controller 30 then finishes the control flow.

As described above, the display control method and the display control device according to the present embodiment each obtain the vehicle state information indicating at least one of the current state of the vehicle 1 and the state of the surrounding environment of the vehicle 1, and when the switch 10 is operated in the preparatory operation, specify, on a basis of the vehicle state information, details of control of the vehicle 1 to be executed in response to the operating command and display, before the confirmatory operation of the switch 10, the details of the control of the vehicle 1 on the display device 2. This enables an occupant to recognize the details of the control of the vehicle 1 before the confirmatory operation of an operating switch. As a result, a driver can grasp a state of the vehicle brought about by the confirmatory operation of the switch 10 and thus can operate the switch 10 with security.

In the present embodiment, details of control of a device, out of onboard devices other than the operation target device of the switch 10, to be executed in response to the operating command from the switch 10 are displayed on the display device 2 before the confirmatory operation of the switch 10. This enables an occupant to recognize, before the confirmatory operation of the operating switch, the details of the control of the onboard device other than the operation target device that is to be subjected to the operation of the switch 10.

The embodiment explained above is described to facilitate understanding of the present invention and is not described to limit the present invention. It is therefore meant that the constituent elements disclosed in the above embodiment include all design changes and equivalents to fall within the technical scope of the present invention.

### DESCRIPTION OF REFERENCE NUMERALS

1 vehicle

2 display device

3 camera

4 distance measurement device

5 operating switch

6 vehicle speed sensor

7 map database

10 switch (SW)

11 steering switch (steering SW)

12 VDC switch (VDC SW)

13 traveling mode switch (traveling mode SW)

14 autonomous driving switch (autonomous driving SW)

15 lane change switch (lane change SW)

20 driving control device

30 controller

31 information obtaining unit

32 detail-of-control specification unit

33 display control unit

34 autonomous driving control unit

1. A display control device comprising:
a switch which is operated in a preparatory operation and outputs an operating command to an operation target device in response to a confirmatory operation after the preparatory operation; and
a controller for controlling a display device and an autonomous driving, wherein the controller:
obtains vehicle state information indicating at least one of a current state of a vehicle and a state of a surrounding environment of the vehicle;
specifies, on a basis of the vehicle state information, a detail of control of the operation target device and deactivation of autonomous driving when the switch is operated in the preparatory operation, the control being to be executed in response to the operating command; and
causes before the confirmatory operation, the display device to display the deactivation of autonomous driving.

2. The display control device according to claim 1, wherein the display device includes at least one of a head-up display, a display installed in a dashboard, and a display included in a navigation system, the head-up display displaying an image on a glass or a projection plate positioned at a front part of the vehicle.

3. The display control device according to claim 1, wherein an operating method for the preparatory operation and an operating method for the confirmatory operation are different from each other.

4. The display control device according to claim 1, wherein the switch detects a touch operation as the preparatory operation and detects, as the confirmatory operation, any one of a touch operation that takes a longer contact time than a contact time of the touch operation for the preparatory operation and an operation of pushing in a part touched in the preparatory operation.

5. The display control device according to claim 1, wherein
the switch is a switch to operate an operation target device, and
the controller causes, before the confirmatory operation, the display device to display the detail of the control of a device out of an onboard device other than the operation target device, the control being to be executed in response to the operating command.

6. A display control method to be executed by a processor, the display control method comprising:
obtaining vehicle state information indicating at least one of a current state of a vehicle and a state of a surrounding environment of the vehicle;
specifying, when a switch is operated in a preparatory operation, a detail of control of an operation target device and deactivation of an autonomous driving, the switch outputting an operating command to the operation target device in response to a confirmatory operation after the preparatory operation; and
causing before the confirmatory operation, the display device to display the deactivation of the autonomous driving.

7. The display control device according to claim 1, wherein the controller:
causes the display device to display reason of the deactivation of the autonomous driving.
